(19) United States
(12) Patent Application Publication
(10) Pub. No.: US 2019/0190915 A1
(43) Pub. Date: Jun. 20, 2019

(54) METHOD AND APPARATUS TO CONFIGURE AND REGULATE NETWORK ACCESS OF DEVICES

(71) Applicants: John Barrera, Fairfield, CA (US); Eric Hackman, San Francisco, CA (US); Peter Barrera, Fairfield, CA (US)

(72) Inventors: John Barrera, Fairfield, CA (US); Eric Hackman, San Francisco, CA (US); Peter Barrera, Fairfield, CA (US)

(21) Appl. No.: 16/223,056

(22) Filed: Dec. 17, 2018

Related U.S. Application Data
(60) Provisional application No. 62/599,597, filed on Dec. 15, 2017.
(60) Provisional application No. 62/612,307, filed on Dec. 29, 2017.
(60) Provisional application No. 62/599,591, filed on Dec. 15, 2017.

(51) Int. Cl. H04L 29/06; H04W 12/08

(52) U.S. Cl. CPC H04L 63/10; H04L 67/42; H04W 12/08; H04L 63/20

(57) ABSTRACT

Different embodiments to improve configuring and/or regulating network access. For example, one embodiment could receive rules set by a parent via her mobile device, and access data from external systems via their corresponding APIs. Based on rules from the parent, and one or more sets of data from the APIs, the embodiment could send control signals to a local device to regulate the network access of a child's electronic device. Other Embodiments can operate to configure a network device for use on a local (e.g., home) wireless network. The configuration can be facilitated by a remote server (e.g., cloud-based server) that can be used to interact with a local wireless modem.

### CROSS-REFERENCE TO RELATED APPLICATIONS

This patent application claims priority to: U.S. Provisional Patent Application No. 62/612,307, filed Dec. 29, 2017, entitled “Method and Apparatus to Regulate Network Access of Devices,” which is incorporated herein by reference, and U.S. Provisional Patent Application No. 62/599,591, filed Dec. 15, 2017, entitled “Method and Apparatus for Balanced Network Access With Local Wireless Network,” which is incorporated herein by reference, and U.S. Provisional Patent Application No. 62/599,597, filed Dec. 15, 2017, entitled “Cloud-Assisted Network Device Configuration and Control With Local Wireless Network,” which is hereby incorporated herein by reference.

### BACKGROUND OF THE INVENTION

It can be difficult for children to control themselves from playing excessively via the web. Currently, there are a number of apps to help parents control the web activities of their children. For example, there is an app that allows parents to list out the chores for their children at a website. After the children have finished their corresponding tasks, they could check off boxes at the site. Then if the parents are satisfied, they could use another app to program a router to let the children access the Internet. The features provided by such apps can be quite limiting.

Another conventional difficulty is that it is cumbersome for a user to configure a network device for use on a local wireless network provided by a local wireless modem. For example, it can be difficult for a user to obtain and enter various alphanumeric data into a user interface in order to configure a network device.

Accordingly, at least there is a need for methods and systems to improve the technical field of configuring and/or regulating network access for enhanced effectiveness, flexibility and ease of use.

### SUMMARY OF THE INVENTION

A number of embodiments regulate network access more effectively, flexibly and in more user-friendly ways. One embodiment could receive rules set by a parent via her mobile device. The embodiment could automatically access data from external systems via their corresponding APIs. Based on at least one or more rules from the parent, and one or more sets of data from the APIs, the embodiment could send control signals to a local device to regulate the network access of a child's electronic device, such as a mobile device of the child.

Other Embodiments of the invention can operate to configure a network device for use on a local (e.g., home) wireless network. The configuration can be facilitated by a remote server (e.g., cloud-based server) that can be used to interact with a local wireless modem. Advantageously, a user can easily have a network device configured for use on a local wireless network provided by a local wireless modem without having to manually enter alphanumeric data into a user interface.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 shows one embodiment.

FIGS. 2A-2B show different embodiments.

FIG. 3 is a block diagram of a network system according to one embodiment.

FIG. 4 is a flow diagram of a registration request process according to one embodiment.

FIG. 5 is a flow diagram of a device configuration process according to one embodiment.

FIG. 6 illustrates process flow for setup of a centralized account according to one embodiment. The centralized account can be then used for SMS registration.

FIG. 7 illustrates process flow for capture of information of a connected home device according to one embodiment.

FIG. 8 illustrates process flow for auto-configure of a connected home device using a SSID (Service Set Identifier) according to one embodiment.

### DETAILED DESCRIPTION OF THE INVENTION

In one embodiment, an apparatus for balanced network access includes at least an API and rules governance computing system (ARGS), a logic checking computing system (LCC), and a gateway access computing system (GAC).

In one embodiment, the GAC can operate at least as a service access point, and a network access point. As a network access point, the GAC could operate as a modem and router, in a confined area, such as a home. It can connect via wire and/or wirelessly different client electronic devices in the confined area to an external network, including the Internet, outside of the confined area. The different client electronic devices could include any Internet capable device, such as game console, tablet, smartphone, laptop, desktop, and loT device.

In one embodiment, both the ARGS and LCC could be one or more servers wired or wirelessly connected to each other via the Internet, hosted in the external network, such as in a secondary or in a tertiary network.

In one embodiment, to operate as a service access point, the GAC affects quality and/or quantity of access to the external network. For example, as a service access point, the GAC could retrieve signals from the LCC to control access to different contents in the external network by a client (e.g. child) electronic device. The signals from the LCC could be based on at least a feed of data from an API (or API feed) related to the client, and rules and controls set by another client (e.g. parent) electronic device. These rules, controls and API feeds can be from the ARGS. In different embodiments, the quantity of access can be the time of day or the total amount of time per day to access the external network; and the quality of access can be the addresses in the external network that are allowed to be accessed.

There could be different types of clients. In the following, the description is mainly on two types of clients: a child client and a client of the corresponding parent of the child.

In one embodiment, the ARGS is configured to receive at least API feeds, Controls and/or Automated rules.

In one embodiment, there could be different types of API feeds that the ARGS receives. Each type of API feeds could provide a feed of data from the API of different external systems, such as systems from news organizations, schools, biometric data, and work; and data from other websites and/or loT devices.

To illustrate, an API could bring in environmental data, such as outside temperature reported in the vicinity of a child electronic device, which could be a mobile device, such as a mobile phone. For example, the ARGS could retrieve location data regarding the location of the child electronic device, and the environmental data from a website, such as www.weather.com, around the location of the child electronic device.

Another example of environmental data includes information regarding the traffic data around the location of the child electronic device. For example, the ARGS could retrieve traffic data from a website, such as www.waze.com, around the location of the child electronic device.

Another API could bring in data from the child's school, including the child's school performance, such as homework completed, the child's school attendance record, and/or the child's grades in different subjects. For example, the ARGS could retrieve such information from a database in the child's school.

One type of API could bring in the child's biometric data, such as from a wearable device of the child. To illustrate, the ARGS could retrieve data from one or more devices worn by the child, to retrieve, for example, the child's heart beat and temperature (which could indicate that the child is sick), or the quality of sleep of the child.

As discussed, the ARGS could receive at least API feeds, Controls, and/or Automatic Rules. The Controls can be considered as different controls set on the fly to provide, for example, balanced network access, while Automatic rules can be considered as rules preset in advance.

In different embodiments, Automatic rules could be temporarily or arbitrarily based. Examples of Automatic rules include (a) addresses in the external network that a child electronic device may be able to access via the GAC; (b) amount of time a child electronic device may access the external network via the GAC; (c) the types of files a child electronic device may access via the GAC, such as .png, .mov, .jpg, .mp4, and .pdf, for example, as a filter for different types of images or adult videos; (d) the date and/or time of day a child electronic device may access the external network via the GAC; (e) the different child electronic devices that a parent electronic device could access via the GAC; and (f) the total amount of network usage time for a child electronic device per hour, per day, per month, and/or per year. In one embodiment, an Automatic rule could be temporary, such as applicable only during a Spring break. In another embodiment, an Automatic rule could be permanent, such as no access to certain URL if GPA is below 1.5. In yet another embodiment, a parent could arbitrarily allow a child electronic device to access the external network via the GAC, if the parent prefers.

In different embodiments, examples of Controls include (a) allowing access to the external network via the GAC, based on evidence indicating completion of certain tasks, such as running a number of miles, and successfully finishing certain homework; (b) denying access to the external network via the GAC based on evidence indicating certain tasks not jet completed, or other factors which may or may not be under a child's control via a client electronic device; (c) setting rules to change the quality and/or quantity of network access dependent on one or more types of API data; (d) setting rules to change the quality and/or quantity of network access independent of one or more types of API data; and (e) overriding any and all previously set rules and controls at any given time.

In different embodiments, the LCC could retrieve the received API feeds and the Controls and the Automatic Rules, and analyze them to generate signals for the GAC to govern conditional use and access to the external network by a child electronic device.

In another embodiment, the signals from the LCC to the GAC could affect the quantity and/or quality of access to the external network. To illustrate, the quantity of access can be allowing a child electronic device to access the external network from 9 pm to 10 pm on a certain day, or for one hour total on the certain day. The quality of access can be certain types of video games a child electronic device could have access via the GAC. Controlling network access would indirectly control how the child could effectively use a child electronic device, such as the device's screen time.

In another example, based on the child's biometric data, depending on whether the child has reached a certain threshold, such as whether the child has run a certain number of miles, or moved by a certain number of steps, the quality and/or quantity of the external network access via the GAC could be affected.

The following provides an example illustrating different operations of the apparatus from when a child requests access.

First, the child via a child electronic device sends a request to the GAC for access to the external network. An example can be the child electronic device requesting the URL or its destination's IP address resolved via a DNS server hosted in the external network.

The GAC can be programmed with the location of the LCC, such as the IP address of the LCC. Based on the LCC location, the GAC can check with the LCC to confirm if the child has a valid account in good standing. If the child has a valid account (e.g. previously registered to use the apparatus) and is in good standing (e.g. subscription fee paid), the LCC would determine if condition(s) for access has been satisfied based on one or more Automatic rules and/or Controls and/or API feeds.

The determination could be an iterative process. For example, the LCC could transmit a confirmation request to the GAC to be sent to the child electronic device. The confirmation request could include a list of tasks to be responded by the child via the child electronic device.

The responses from the child and/or the child electronic device to the GAC could include UserID, State of Response (yes/no/in progress), Proof of condition met (eg. chore completed), and/or Metadata (Time of request, DeviceID of the child, coordinates of the Client ID, Time balance for network access).

The GAC could transmit the child's responses (e.g. UserID, Stat of Responses, Metadata, Proof) to the LCC.

The LCC associates the child account with another client account, which in this case could be an account of the parent corresponding to the child. Based on the association, the LCC accesses corresponding Automatic rules, Controls and data from API feeds from the ARGS.

The LCC, based on the Automatic rules and Controls, operates on the accessed data from the API feeds and the child's responses to determine if there is complete, conditional (quantity and/or quality of network access) or no access to the external network given to the child electronic device.

For example, if the decision is to allow the child full access to the external network via the child electronic device, then the GAC will allow all network access requests from the child electronic device. If the decision is not to allow access to the external network, then the GAC will forbid the child electronic device to access the external network. If the decision is conditional, then the GAC would control accordingly. For example, the GAC could restrict a limited amount of time the child electronic device could access; the GAC could set a limited number of addresses or locations the child electronic device could access, such as no accessing of mobile browsers; or the GAC could allow only a limited set of child electronic devices to access the external network, such as no mobile phones could access the external network, or only a Xbox could access the external network. Note that in one embodiment, the parent in the above scenario could arbitrarily restrict or remove access to the external network, overriding all previous decisions and/or permissions.

A number of embodiments have been described regarding the LCC using the GAC to control access to the external network. Note that in one embodiment, the external network could include a local area network in a confined area, such as an apartment, and the GAC could operate as a network access point for the local area network for a child electronic device in the apartment. To illustrate, the GAC could restrict the child electronic device from accessing another electronic device in the apartment via the local area network.

In the above example illustrating different operations of the apparatus from when the child requests access, the ARGS is assumed to have the corresponding Automatic rules and Controls. In one embodiment, at least some of the Automatic rules and Controls are from the parent. Assuming that the parent is a registered user, a parent electronic device could have accessed the ARGS via the GAC to enter the corresponding Automatic rules and Controls.

A number of embodiments have been described regarding clients being a child and a parent. Other clients are applicable, such as an employer and an employee.

A number of embodiments have been described regarding an apparatus with an ARGS, a LCC, and a GAC, where the GAC operates as a network access point and a service control device. In another embodiment, the GAC operates only as a service control device, but the GAC is coupled to and controls a network access device.

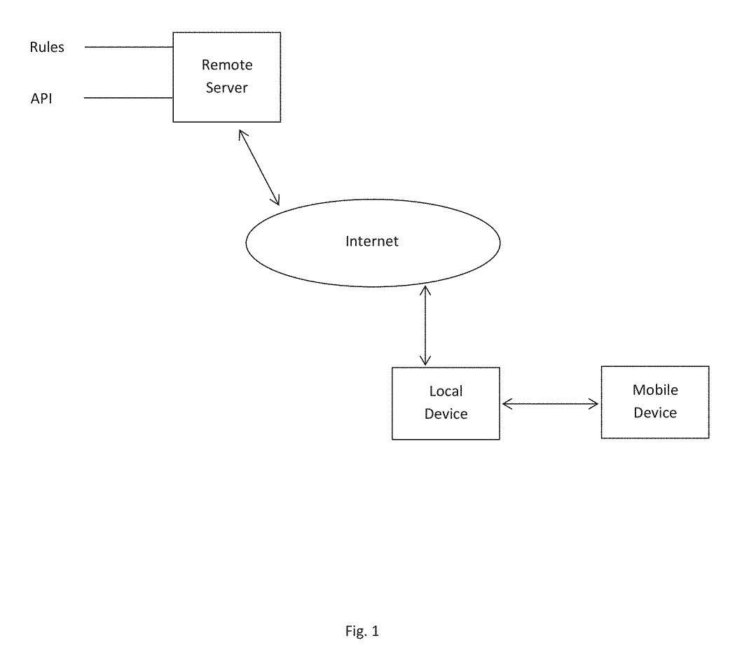

FIG. 1 shows another embodiment. It includes a remote server that could control a local device via the Internet based on rules and APIs. Through the control from the remote server, the local device can regulate network access of one or more electronic devices in a local area (such as a home) via a local area network. The electronic devices could be mobile devices belonging to a child. The rules could include one or more rules set by, for example, a parent or a supervisor regarding regulating the network access. The APIs could include one or more APIs for data from other systems regarding regulating the network access. The other systems could include, for example, a school system with information on homework and test grades of the child; or a system on current weather around the local area. The network access regulation could include regulating accessing a website via the Internet and/or accessing one or more other electronic devices in the local area via the local area network. In different embodiments, the remote server could include an ARGS and a LCC, while the local device could include a GAC. The local device could also include a modem and/or a router.

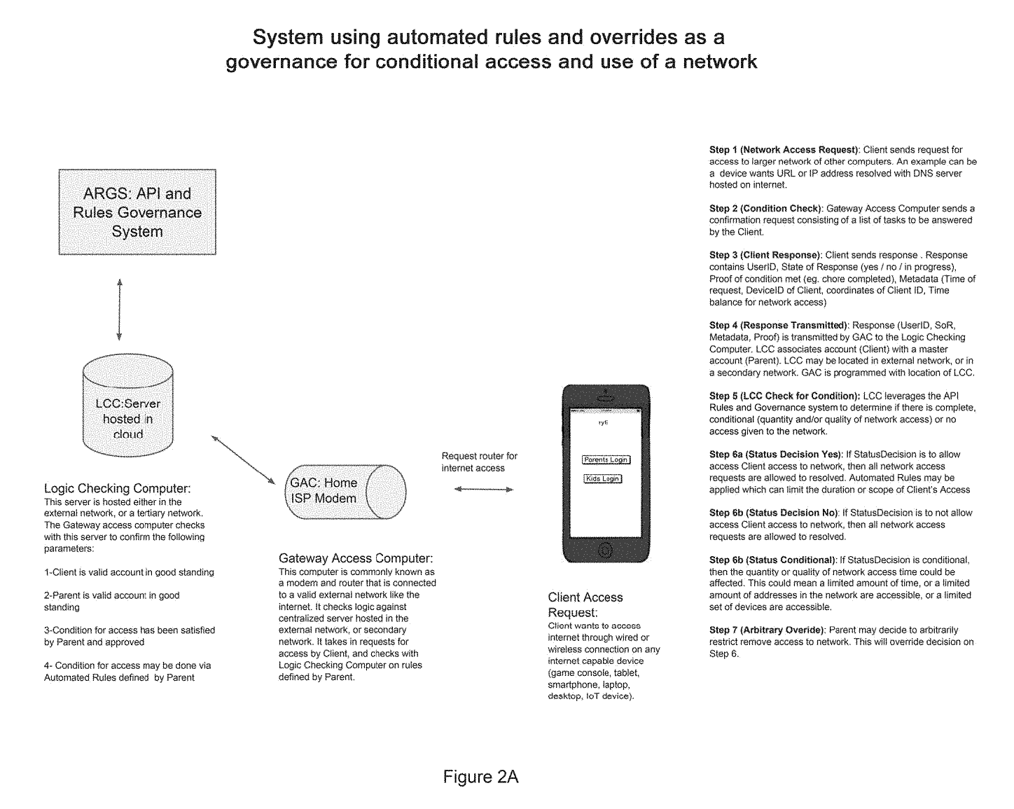

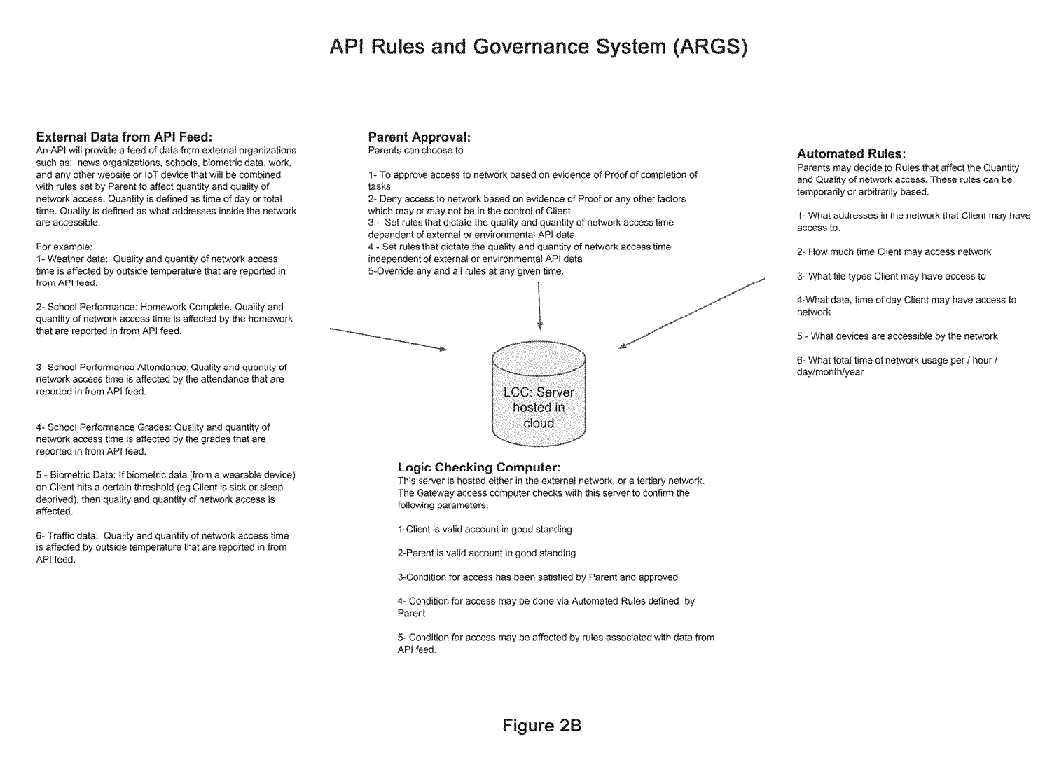

FIGS. 2A-2B show different embodiments.

A number of embodiments have been described. They could significantly improve the technical field of regulating network access. For example, the embodiments could receive rules set by a parent via her mobile device. The embodiments could automatically access data from external systems via their corresponding APIs. Based on at least one or more rules from the parent, and one or more sets of data from the APIs, control signals could be sent to a local device to regulate the network access of a child's electronic device, such as a mobile device of the child.

Other embodiments of the invention can operate to configure a network device for use on a local (e.g., home) wireless network. The configuration can be facilitated by a remote server (e.g., cloud-based server) that can be used to interact with a local wireless modem. Advantageously, a user can easily have a network device configured for use on a local wireless network provided by a local wireless modem without having to manually enter alphanumeric data into a user interface.

In one embodiment, a connected home device can wirelessly communicate locally with local wireless network access device (or a local wireless modem) to register a network device (e.g., connected home device) with the local wireless network access device or the local wireless modem (or with a local wireless network provided by thereby).

According to one implementation, a QR code can be provided with or on a network device, and to initiate configuration, a user can capture an image (e.g., photo) of the QR code and then cause the image to be electronically transmitted to a remote server. The remote server can then decipher the QR code and then send a configuration request to the local wireless network access device to cause the local wireless network access device to configure itself to permit communication with the network device.

According to another implementation, a QR code can be provided with or on the network device, and to initiate the configuration, a user can capture an image (e.g., photo) of the QR code and then cause the image to be electronically deciphered into an identifier (e.g., SSID) and a password, and then transmit such to a remote server. The remote server can then send a configuration request to the local wireless modem to cause the local wireless modem to configure itself to permit communication with the network device.

According to sill another implementation, to initiate the configuration, a user (i.e., account holder) can make use of a microphone and/or camera that can be provided with or on a network device, a local wireless network access device or a local wireless modem to capture an identifier (e.g., SSID) and a password directly or a code (which can be electronically deciphered into an identifier (e.g., SSID) and a password), and then transmit such to a remote server. The remote server can then send a configuration request to the local wireless network access device or the local wireless modem to cause the local wireless network access device or the local wireless modem to configure itself to permit communication with the network device.

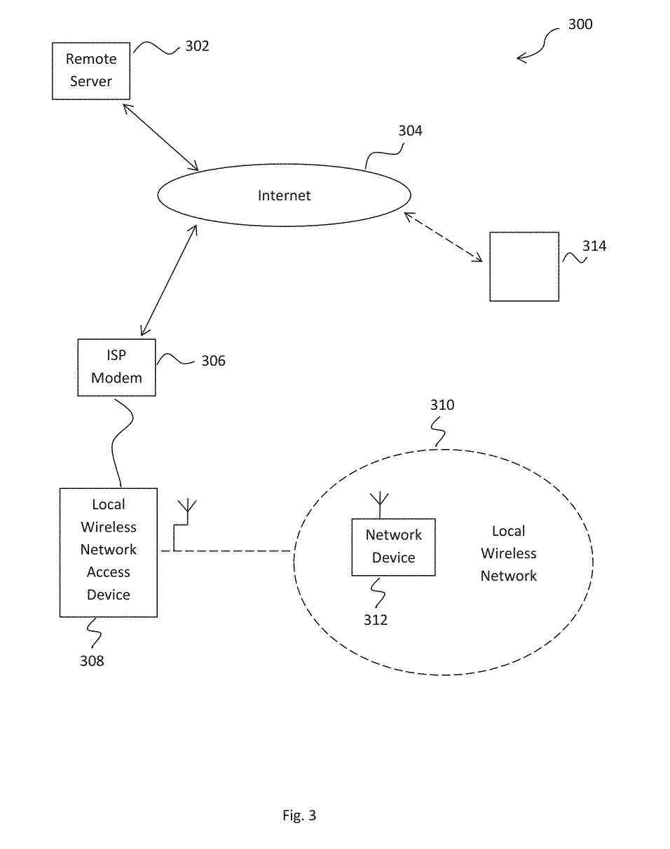

FIG. 3 is a block diagram of a network system 300 according to one embodiment. The network system 300 can include a remote server 302 that couples to the Internet 304 (i.e., global public network). The network system 300 can support a plurality of users. Each user (e.g., account holder) can have at their location (e.g., home, office, etc.) a ISP modem 306, a local wireless network access device 308, a local wireless network 310, and a network device 312. The ISP modem 306 can couple to the Internet 306 to provide a wired access point at the user's location. The local wireless network access device 308 can couple to the ISP modem 306 and operate to provide a local wireless network 310 at the user's location. One or more network devices 312 can be configured to operate on the local wireless network 310. Also, the one or more network device 312, once configured, can be controlled in accordance with a user's desires. The control can, in one embodiment, be achieved using a mobile electronic device 314 (e.g., smart phone, tablet, mobile computer) that can couple to the Internet 304 so as to send and receive data with the remote server 302, such that the remote server 302 can in turn instruct the appropriate local wireless network access device 308 to manage use of the local wireless network 310 generally or in regard to specific network devices 312. The mobile electronic device 314 might simply send instructions to the remote server 302 via text message or email. Alternatively, the mobile electronic device 314 can run a software application that provides a graphical user interface that facilitates receiving instructions from a user and also presents status information pertaining to the local wireless network 310 and usage thereof by the one or more network device 312.

In an alternate embodiment, the local wireless network access device 308 can be incorporated into the ISP modem 306.

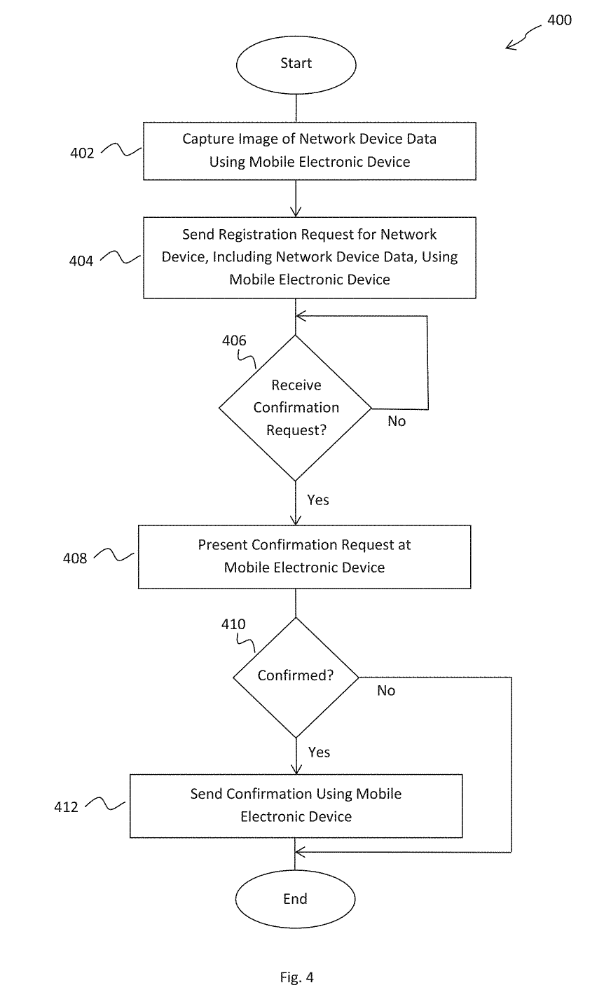

FIG. 4 is a flow diagram of a registration request process 400 according to one embodiment. Registration request process 400 is, for example, performed by a mobile electronic device. Examples of the mobile electronic device include a smart phone, a tablet computer, a portable computer, and the like. For example, the mobile electronic device can be the mobile electronic device 314 shown in FIG. 3.

The registration request process 400 can capture 400 into an image of network device data using the mobile electronic device. The network device data can, for example, be provided on the network device itself or can be provided in close proximity thereto, such as packaging or labeling. In one implementation, the network device data is provided as a QR code. However, in other embodiments, the network device data can be provided as text and/or image, coded or uncoded.

After the image of the network device data has been captured 402, a registration request for the network device can be sent 404 using the mobile electronic device. The registration request can, for example, include an account identifier and the network device data. The account identified can, for example, be a telephone number or an email address. The network device data can be provided by way of the captured image, in one embodiment. In another embodiment, the network device data can be resolved or acquired from the caption image and provided as alphanumeric data.

Next, a decision 406 determines whether a confirmation request has been received. Here, the registration request process 400 waits for a confirmation request from a remote server to which the registration request has been sent 404. When the decision 406 determines that a confirmation request is not yet been received, the registration request process 400 can await such a request. Once the decision 406 determines that a confirmation request has been received, the registration request process 400 can present 408 the confirmation request at the mobile electronic device. Then, a decision 410 can determine whether an account holder confirmation has been received. Here, the account holder can interact with the mobile electronic device to provide a confirmation in response to the confirmation request. When the decision 410 determines that the account holder has provided the requested confirmation, a confirmation can be sent 412 using the mobile communication device. Here, the confirmation being sent 412 can be transmitted to the remote server.

On the other hand, when the decision 410 determines that the account holder confirmation as not been received, that is, the account holder has declined to confirm or such is presumed by lack of response, then the registration request process 400 can end without confirmation. Optionally, the registration request process 400 can also send a confirmation denied message to the remote server.

Regardless, after the confirmation has been sent 412 or bypassed if confirmation is denied, the registration request process 400 can end.

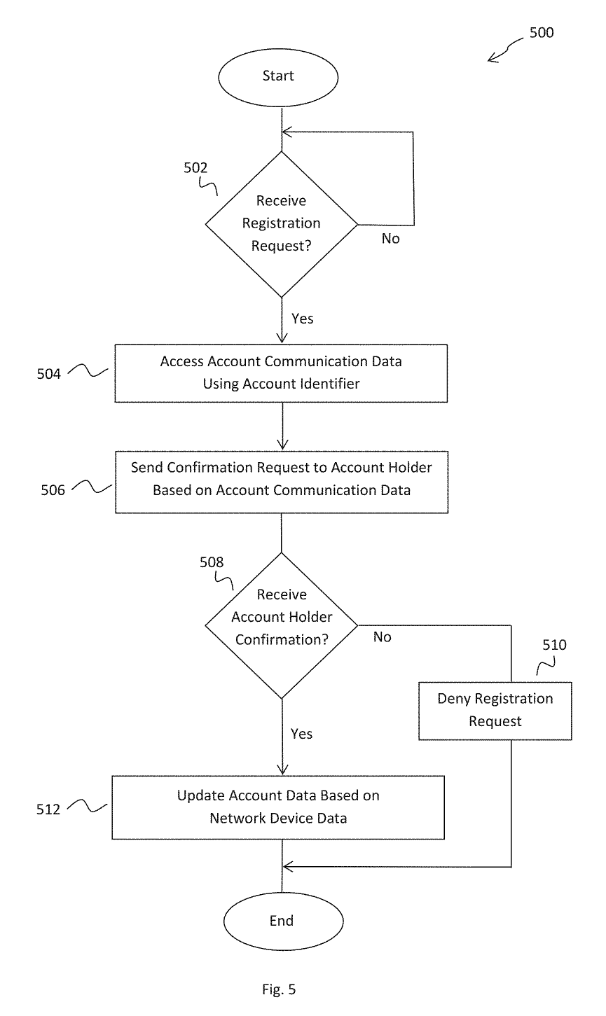

FIG. 5 is a flow diagram of a device configuration process 500 according to one embodiment. The device configuration process 500 can, for example, be performed by a remote server. For example, the remote server can be the remote server 302 illustrated in FIG. 3. The device configuration process 500 can represent a server-side process that interacts with the registration request process 400, which can be considered a client-side process.

The device configuration process 500 can begin with a decision 502 that determines whether a registration request has been received. When the decision 502 determines that a registration request is not yet been received, the device configuration process 500 can await such request.

Once the decision 502 determines that a registration request has been received, account communication data can be access 504 using an account identifier. The account identifier can be obtained from the registration request that has been received. A confirmation request can then be sent 506 to the account holder based on the account communication data. For example, the confirmation request can be sent 506 by text message or email message.

A decision 508 can then determine whether an account holder confirmation has been received. When the decision 508 determines that an account holder confirmation has not been received, the registration request can be denied 510. After the registration request is denied 510, the device configuration process 500 can end.

On the other hand, when the decision 508 determines that the account holder confirmation has been received, account data can be updated 512 based on network device data. In one embodiment, the network device data is provided with the registration request and identifies a SSID and password associated with the network device that is to be configured. In one embodiment, the captured image of the network device data can be used initially to take an image of the network device data provided on or with the network device and then be processed to extract the alphanumeric network device data. Following the block 512, the device configuration process 500 can end with the network device being registered and operable for use on a local network (e.g., local wireless network).

Once a particular network device is configured for use on a local wireless network, the remote server can operate to receive and process user commands for a local wireless network access device which can pertain to usage of the local wireless network via the particular network device. Exemplary commands that can be used in this regard are provided in the examples below. In the following examples, “ryfi” is the name of a local wireless network device (e.g., network device 312) being interacted with.

EXEMPLARY SUPPORTED COMMANDS

Get ryfi status

COMMAND: ryfi status

POSSIBLE RESPONSES
1. ryfi is ON.
2. ryfi is OFF.
3. ryfi could not be reached (the power or home internet may be off).
4. ryfi is ON for the next [insert time remaining]. (To cancel the timer, just send the ryfi off command.)
5. ryfi is OFF for the next [insert time remaining]. (To cancel the timer, just sent the ryfi on command.)

Turn ryfi ON immediately

COMMAND: ryfi on

POSSIBLE RESPONSES
1. ryfi is now ON.
2. ryfi could not be reached (the power or home internet may be off).
3. An error prevented ryfi from turning on.

Turn ryfi OFF immediately

COMMAND: ryfi off

POSSIBLE RESPONSES
1. ryfi is now OFF.
2. ryfi could not be reached (the power or home internet may be off).
3. An error preventing ryfi from turning off.

Get help

COMMAND: help

POSSIBLE RESPONSES

Your ryfi will respond to the following text commands (upper/lowercase doesn't matter):
1. ryfi status (Is my ryfi on or off?)
2. ryfi on (Turn my ryfi ON immediately.)
3. ryfi off (Turn my ryfi OFF immediately.)
4. set timer (Turn my ryfi ON or OFF for a certain amount of time.)
5. help (Get help.)

Set a timer

COMMAND: set timer

POSSIBLE RESPONSES
1. Set your ryfi ON or OFF?

SECOND COMMAND: on/off

POSSIBLE RESPONSES
1. Set your ryfi ON/OFF for how many minutes? (1-720)

THIRD COMMAND: (number from 1 to 720)

POSSIBLE RESPONSES
1. Done! Your ryfi is ON/OFF for the next (number) minutes. You can cancel the timer early by sending the ryfi off/on command.
2. Sorry, we didn't understand your response. Please enter the number of minutes for your timer between 1 and 720.

NOTES for the set timer command:

Any of the above commands could also have the following response:
ryfi could not be reached (the power or home internet may be off). No timer has been set.

Since this command requires multiple messages back and forth with the user, the “session” could time out after 5 minutes. If the user does not send the next required command within 5 minutes of the previous command (idle for 5 minutes), the command could be dropped and the user should have to start over. In this case, the following response could be sent after 5 minutes of idle time: “It has been 5 minutes since we received your last command. To ensure you are the only one managing your ryfi, please start over setting your timer. Thanks!”

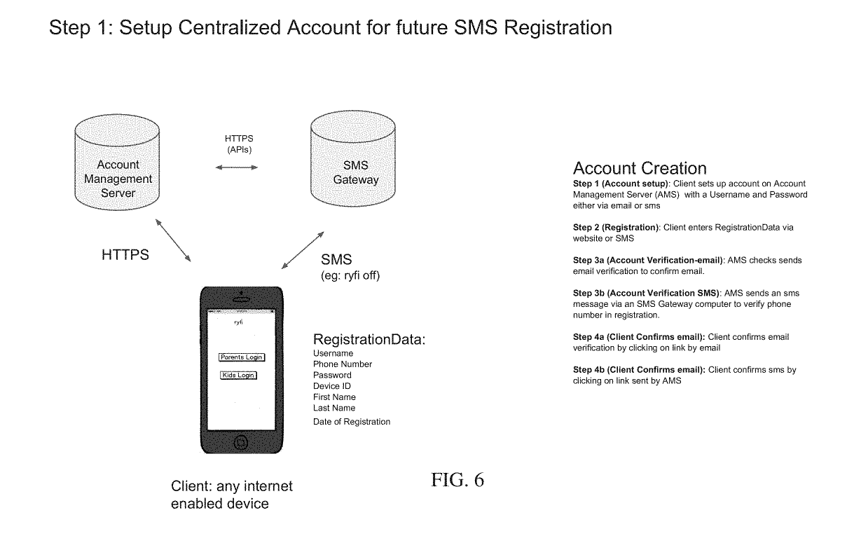

FIG. 6 illustrates process flow for setup of a centralized account according to one embodiment. The centralized account can be then used for SMS registration.

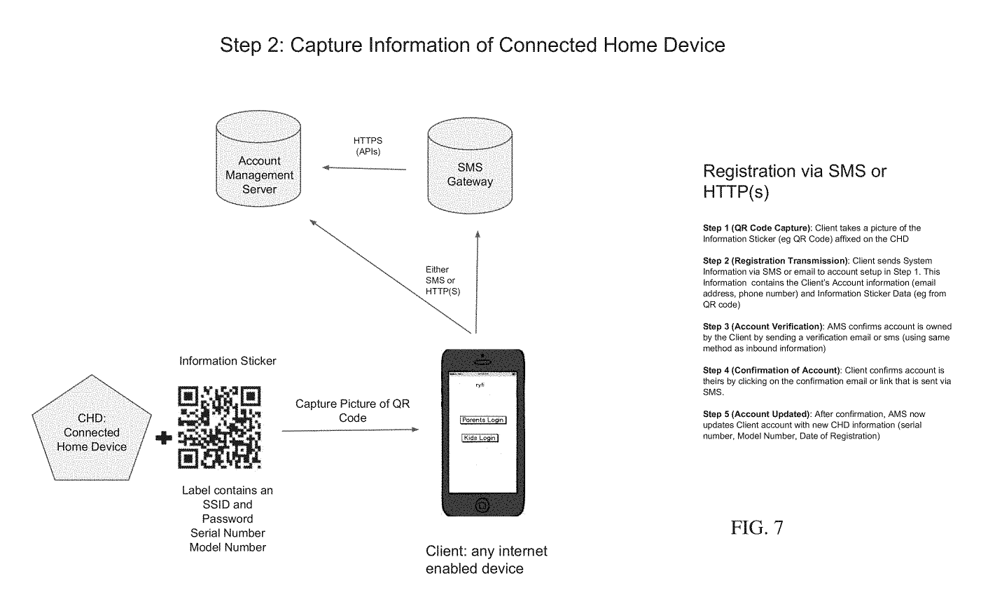

FIG. 7 illustrates process flow for capture of information of a connected home device according to one embodiment.

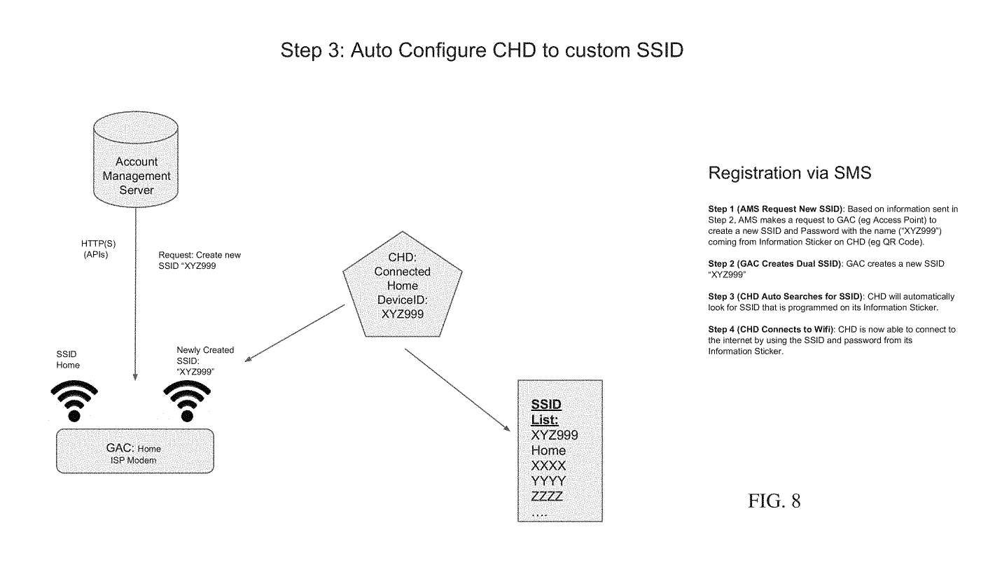

FIG. 8 illustrates process flow for auto-configure of a connected home device using a SSID (Service Set Identifier) according to one embodiment.

The invention can be implemented in software, hardware or a combination of hardware and software. A number of embodiments of the invention can also be embodied as computer readable code on a computer readable medium. The computer readable medium is any data storage device that can store data which can thereafter be read by a computer system. Examples of the computer readable medium include read-only memory, random-access memory, CD-ROMs, magnetic tape, optical data storage devices, and carrier waves. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description and, thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

The various embodiments, implementations, features and aspects of the invention noted above can be combined in various ways or used separately. Those skilled in the art will understand from the description that the invention can be equally applied to or used in other different settings with respect to various combinations, embodiments, implementations or features provided in the description herein.

What is claimed is:

1. An apparatus, device, system, method, user interface and/or computer readable medium for providing structures and/or functionalities for one or more features and/or aspects described herein.
